(19) United States
(12) Patent Application Publication
(10) Pub. No.: US 2008/0306995 A1
(43) Pub. Date: Dec. 11, 2008

(54) AUTOMATIC STORY CREATION USING SEMANTIC CLASSIFIERS FOR IMAGES AND ASSOCIATED META DATA

(76) Inventors: Catherine D. Newell, Rochester, NY (US); Mark D. Wood, Penfield, NY (US); Kathleen M. Costello, Rochester, NY (US); Robert B. Poetker, Penfield, NY (US)

Correspondence Address: Frank Pincelli;Patent Legal Staff, Eastman Kodak Company, 343 State Street, Rochester, NY, 14650-2201, US

(21) Appl. No.: 11/758,358

(22) Filed: Jun. 5, 2007

(51) Int. Cl. G06F 17/30

(52) U.S. Cl. 707/104.1; 707/E17.019

(57) ABSTRACT

A method and system for automatically creating an image product based on assets stored in a user database. A number of stored digital media files are analyzed to determine their semantic relationship to an event and are classified according to requirements and semantic rules for generating the image product. These requirements and rules refine the association between the assets and the event for which the image product is generated. The assets which best meet the requirements and rules of the image product are ranked and the highest ranking ones are included in the image product.

### TECHNICAL FIELD OF THE INVENTION

This invention pertains to multimedia authoring systems, software, and product distribution media. In particular, this invention automatically generates a multimedia presentation based on a user's stored media files, thereby automatically generating for a user a customized multimedia story.

### BACKGROUND OF THE INVENTION

It is widely acknowledged that viewing images in the form of a multimedia presentation, referred to herein as a “story”, or a hardcopy thematic album is much more compelling than browsing through a number of random hard-copy prints, or looking at a random series of static images presented sequentially using a slide projector, computer, or television. The selective addition of other elements to the presentation such as a sound track appropriate to the content of the images, the insertion of interesting transitions between the images, the addition of a video clip or the creation of various video-style special effects including fades and dissolves, image-collaging, backgrounds and borders, and colorization makes the presentation much more interesting to the viewer and can greatly enhance the emotional content of the images being presented. The proliferation in the home of new television-based viewing platforms able to accommodate multimedia, including DVD and Video CD players, also increases the demand for this type of presentation.

For the ordinary photographic consumer, the creation of a multimedia presentation or album of still images is not presently very convenient. The selection and layout of digital images can be a significant and time consuming process. Even if the images are available in digital form, a consumer must have facility with multimedia authoring software tools such as Macromedia Director™ or Adobe Premier™ in order to create such a presentation. These software tools, while very flexible, are aimed more at the professional presentation creator, have multiple options, and require a great deal of time and experience to develop the skill needed to use them to advantage. More recently, template-based multimedia presentation applications such as Photojam™, offered by Shockwave.com, or PC-based “movie making” applications such as Apple's I-Movie™ have become available. While these applications can simplify the creation of multi-media presentations for a consumer, they do not help to automate many of the story making options. Current applications often require the user to select a presentation theme and to select the assets, such as pictures and music, that are used to automatically generate an image product. In addition, these applications offer no way to automatically generate an image product such as for special occasions, holidays, anniversaries, or for selected other calendar events.

Thus, there remains a need for an automated authoring system where an inexperienced user can receive an automatically-generated multimedia story and obtain copies of the presentation over a variety of channels and in a variety of formats suitable for multiple types of presentation devices

### SUMMARY OF THE INVENTION

In answer to these and other needs, and in accordance with one preferred embodiment of the present invention, there is provided a method for automatically generating a customized story (or image product) of a set of digital media files provided by a user on a digital storage device, comprising the steps of analyzing the digital media files for semantic information, including metadata, and organizing the digital images in association with a selected presentation format and on a medium that can be viewed by the user, the format automatically chosen in accordance with the semantic and metadata information, or preselected by the user or by the computer system.

Another preferred embodiment of the present invention is a method, software, and a programmed computer system for automatic story-creation from a collection of assets (still images, video, music, public content) utilizing prescribed template rules applied to the collection. The template rules rely on metadata associated with the assets, personal profile and/or user preference data acquired from the user. Metadata can be in the form of EXIF data, index values from image understanding and classification algorithms, GPS data, and/or personal profile/preferences. These rules or a subset of them, when automatically applied to a collection within the system, will produce a story for rendering via a multimedia output engine. The story can be delivered to the user on a variety of storage media such as CDs, DVDs, magnetic discs, and portable flash memory media. The story can be transmitted via cellular networks, by satellite providers, over local and wired area networks. The story can be received and viewed by the user on a variety of hand held display devices such as PDAs, and cell phones. The story can be received at a home and displayed on a computer, television, or over theater style projection systems.

Another preferred embodiment of the invention comprises a method for automatically creating an image product comprising the steps of obtaining a plurality of digital media files associated with an event such as a birthday, holiday, anniversary or other occasion. Classifying the event is accomplished based on analyzing the digital media files and automatically determining a format of an output product based upon the analysis, and then selecting which ones of the digital media files will be included in accordance with requirements of said output image product.

Another preferred embodiment of the invention comprises a method for automatically analyzing a plurality of digital media files with particular attention to their associated metadata, which might include derived metadata. Based on this analysis, one preferred method involves automatically determining the occurrence and number of occurrences of substantial similar metadata elements among the digital media files. These are then automatically grouped based on the number of times a particular meta data element occurs. That information is then used for classifying the digital media files. An image product is generated using the digital media files having the most frequently occurring meta data elements incorporated therein.

Another preferred embodiment of the invention comprises a program storage device storing a computer program for execution on a computer system. The program is capable of automatically generating an image product utilizing a number of digital media files that are resident in the computer system. The program is designed to first detect an image product trigger which might be a calendar date, a user request for an image product, or an upload to the computer system of a plurality of digital media files such as images, sound files, video, etc. The program locates a plurality of digital media files associated with an event if it's a calendar event, for example, or, if the trigger is an upload of media files, the program will determine if the media files satisfy an output product format type. The program automatically classifies the plurality of digital media files based on analyzing metadata associated therewith and automatically selects those files, based on the classifying step, that satisfy an output product format type. The selected media files are ranked based on one or more of a variety of metrics, such as an image value index, and some or all of the ranked files are included in an appropriate image product format that is related to the event.

These, and other, aspects and objects of the present invention will be better appreciated and understood when considered in conjunction with the following description and the accompanying drawings. It should be understood, however, that the following description, while indicating preferred embodiments of the present invention and numerous specific details thereof, is given by way of illustration and not of limitation. Many changes and modifications may be made within the scope of the present invention without departing from the spirit thereof, and the invention includes all such modifications.

### BRIEF DESCRIPTION OF THE DRAWINGS

FIG. 1 illustrates an aspect of a computer system utilizing the present invention;

FIG. 2 illustrates one method embodiment of automatically selecting assets for an image product;

FIG. 3 illustrates one method embodiment of automatically selecting assets for an image product in addition to the embodiment of FIG. 2;

FIG. 4 illustrates example metadata elements that an embodiment of the invention might use to generate semantic relationships among product assets;

FIG. 5 illustrates an example semantic network utilized by one embodiment of the present invention;

FIG. 6 illustrates an embodiment of a user interface for entering metadata associated with people, places, image assets, etc.;

FIG. 7 illustrates an embodiment of a user interface for entering metadata associated with images;

FIG. 8 illustrates communication schemes for sending notifications that image products are completed and for sending the image products themselves;

FIG. 9 illustrates a second example semantic network utilized by an embodiment of the present invention in addition to the example of FIG. 5; and

FIG. 10 illustrates program logic for implementing a portion of one embodiment of the present invention.

### DETAILED DESCRIPTION OF THE INVENTION

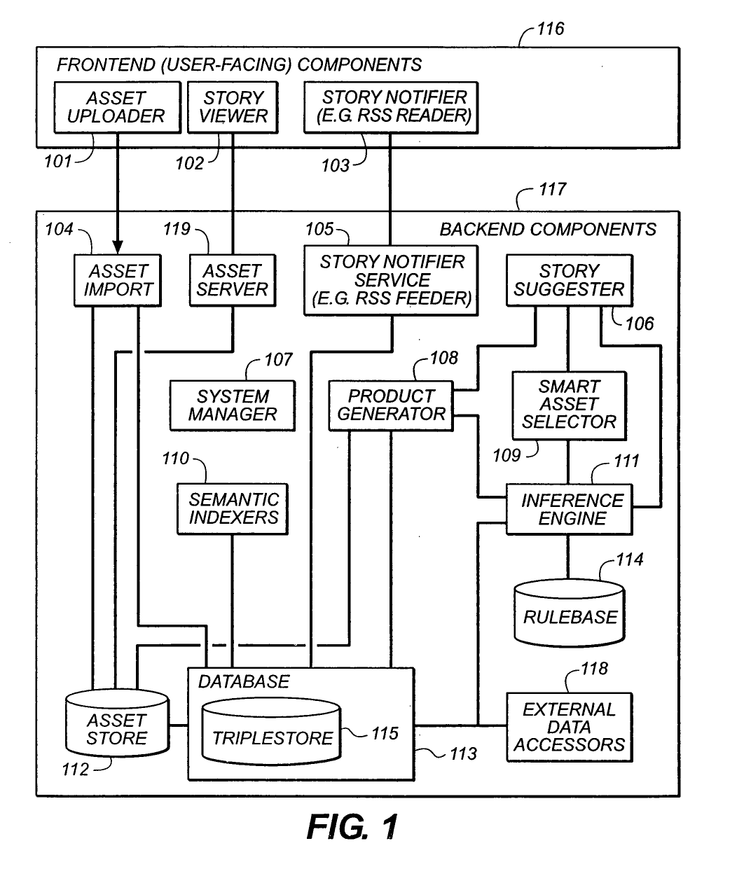

With respect to FIG. 1, there is illustrated an embodiment of the basic system components in a cooperative implementation for practicing the present invention. The top portion of the FIG. 116 shows an embodiment of the user interface components including an asset uploader 101 for uploading assets such as pictures, other images, graphics, music, etc. An embodiment of a story viewer 102 for viewing an image product on a monitor or other display apparatus is coupled to the system. The story viewer can utilize a computer system connection to a network, such as an internet connection for sending completed multimedia stories to another computer system for display. It can also utilize a network connection for sending completed stories over a cell network to a hand held device such as a multimedia capable cell phone or PDA. A story notifier 103 is used for notifying a user that an image product has been generated by the system. The story notifier can also utilize a computer system connection to an RSS feed for sending notifications that a story has been generated. It can also utilize a network connection for sending similar notices over the internet to another computer system, or over a cell network to a hand held device such as a cell phone or PDA. In the latter instance, an SMS message format can be implemented.

The bottom portion of FIG. 1, 117, illustrates the backend components of an embodiment of a portion of the present invention. Although FIG. 1 shows an example type of system architecture suitable for implementing the present invention—one based upon the client-server paradigm—the reader will appreciate that the system components may be structured in other ways without fundamentally altering the present invention. In particular, the illustrated system components may all be resident on the same host system, or they may be distributed across a large or small computer network among different hosts in a number of ways, as in a distributed computer system. For example, the story notifier, asset uploader, asset store, etc, can each be resident on one or more separate host systems coupled over a LAN or WAN. Moreover, each of these host systems might be operated by one or more service providers each offering specialized services and charging a fee. In a preferred embodiment, the backend system components 117 pass information amongst themselves via an intermediary database 113; however, it will be appreciated by those skilled in the art that other communication paradigms, including system buses, network packets (Internet and cell networks), message passing, and publish-subscribe may also be used. Moreover, the backend components 117 may be shared by multiple users, as is typically the case with web-based services for Internet connected devices. In such a preferred embodiment, the asset store 112 and the database 113 will contain assets and information from multiple users.

With reference to the front-end user interface, the user introduces selected assets into the system by activating the asset uploader 101. This component then communicates with the server-side asset import 104 component. The asset import functions to store copies of the assets into the asset store 112 and informs the system manager 107 that it has completed the upload. In one preferred embodiment, communication between the asset import and system manager occurs via the database 113, however, each of the back-end components can be implemented to communicate directly with the system manager 107. For ease of illustration, FIG. 1 does not show connection lines between the system manager 107 and the various other back-end system components, however, the components 104-106, 108-110, 112-113, and 115 are coupled to the system manager. The system manager 107 initiates the semantic indexing process whereby various semantic information is extracted, or deduced, from the uploaded assets' metadata and stored in the database 113. For example, these algorithms can include scene classifiers to categorize a scene into one or more scene types (i.e., beach, indoor, outdoor, etc.), face detection to determine the presence of faces in images, and face recognition to identify a person in an image using facial features. The indexers 110 also include event segmentation algorithms that automatically sort, segment, and cluster an unorganized set of assets into separate events and sub-events.

The semantic indexers 110 include metadata extraction mechanisms for extracting metadata included in the digital asset, as explained above, and recording it in the database. Other examples of such metadata would be the capture date and time, among many other examples as described herein. The indexers can also include complex algorithms that analyze a stored asset to generate more complex metadata. For example, these algorithms can include scene classifiers which identify or classify a scene into one or more scene types (i.e., beach, indoor, etc.) or one or more activities (i.e., running, etc.); face detection which is used to find as many faces as possible in image collections; and people recognition. People recognition is the identification of a person using facial features and/or other contextual information such as clothing identification, etc. The indexers 110 also include algorithms that operate on sets of assets such as event segmenters which automatically sort, segment, and cluster an unorganized set of media into separate temporal events and sub-events. All of the generated metadata is recorded in the database 113 and are appropriately associated with its corresponding database asset. In a preferred embodiment, the generated metadata may be stored in the triplestore 115, a type of database optimized for storing large quantities of unstructured data.

When the last semantic indexer has completed, or at least a sufficient number of indexers have completed, the system manager 107 will activate the story suggester 106 to determine if one or more appropriate stories should be created, which will result in generating an image product. The story suggester in turn will activate the inference engine 111 for evaluating the various rules stored in the rule base 114 to determine if any of the story rules stored therein can be satisfied. One preferred embodiment of the inference engine is the Prolog inference engine having the rule base 114 represented as a set of Prolog clauses stored in an XML file and evaluated by the Prolog engine as requested.

When the story suggester is searching for stories to create based upon an event, such as an anniversary, holiday, birthday, etc., the story suggester 106 requests that the inference engine 111 evaluate the Prolog clause suggestStoryByEvent, looking for valid bindings for several free variables, including but not necessarily limited to the user, the story type, the intended recipient, and the product type. If a valid set of variable bindings is identified, the story suggester will then obtain from the smart asset selector the appropriate set of assets to go with the suggested story, and then request that the product generator 108 create the desired product representation. The product generator will create one or more files of the appropriate format representing the image product, and store the resulting file(s) in the asset store 112. The system manager 107 is notified by the product generator when the image product has been generated, at which point the system manager alerts the story notifier service 105, which in turn causes the story notifier 103 to inform the user that a new product has been created. In addition to the notification methods described earlier, the notification may be in the form of a pop-up window on a display containing text and graphics information indicating that an image product has been created and is ready for viewing. The user may then view the product using the story viewer 102. The story viewer may be implemented as a browser such as Internet Explorer, or a video playback device such as Windows Media Player. In a preferred embodiment, the user has the option to request from the story viewer a hard-copy rendition of the product, such as a bound photo album, if appropriate. To display the product, the story viewer requests and obtains the necessary assets from the asset server 112. The system manager may also launch the story suggester on a periodic basis, such as nightly, to determine if calendar event driven stories can be created from digital media files stored on the computer system. The reader will appreciate that alternative architectures may result in fundamentally the same behavior. For example, the story suggester 106 and smart asset selector 109 components may be combined into a single component, or the story suggester may directly invoke the smart asset selector to determine that the appropriate set of assets are available for a particular story. FIG. 1 illustrates a database storing at least some subset of metadata in a type of database known as a triplestore, but other types of databases, or combinations thereof, including relational databases, may also be employed. Some metadata may be obtained from third-party sources, such as weather or calendar services, as indicated by external data accessors 118.

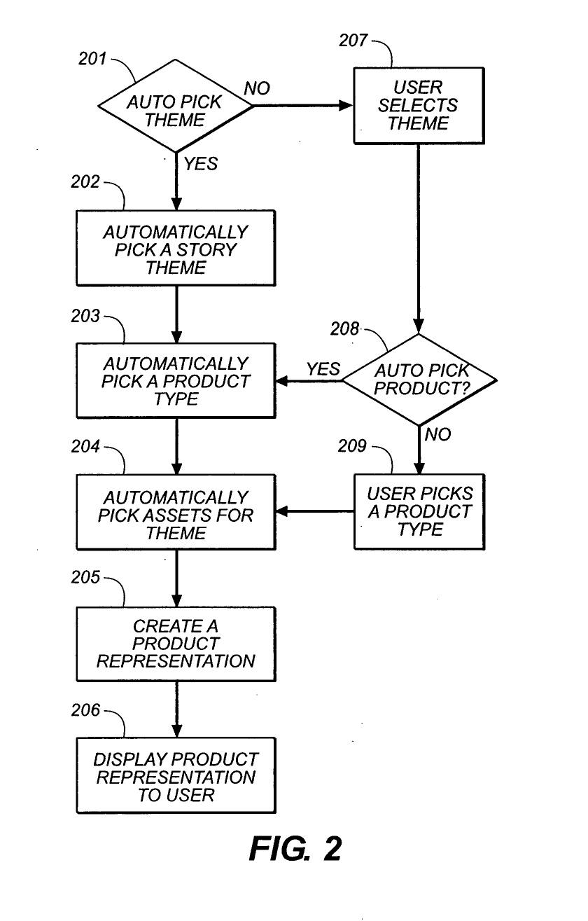

With reference to FIG. 2 there is illustrated a flow chart showing one preferred embodiment of a method for generating an image product. At step 201 a theme for a story can either be automatically selected or it can be manually selected by a user. An example of a theme is Mother's Day. If automatically selected at 202 then a product type is automatically selected at 203 and assets are automatically selected from an asset database, based on the product theme, at step 204. Optionally, if the user selects the theme at step 207, then the user also has the option of selecting a product type at step 209 or having the product type be automatically selected at step 203. After the user selects the product type at step 209, the assets are automatically selected from an asset database, based on the product theme, at step 204. At step 205 the image product (or product representation) is automatically created by programmed steps as described herein, and is presented to the user for approval at step 206.

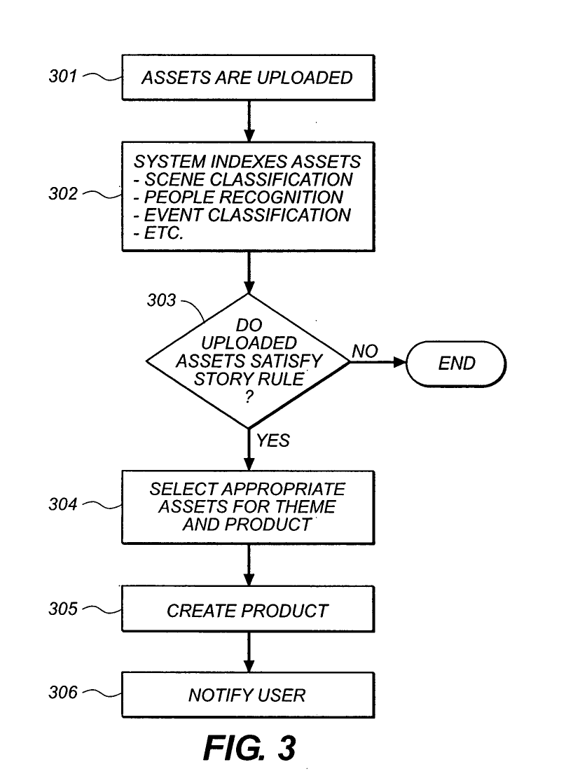

With reference to FIG. 3 there is illustrated a flow chart showing one preferred embodiment of a method for generating an image product. At step 301 assets are uploaded to a computer system to be stored. At step 302 the system generates metadata to be stored with the assets. The metadata includes scene and event classification, and people recognition, among other metadata that the system generates as described herein. Based on the generated metadata, the system determines whether the uploaded assets satisfy a story rule at step 303. If not, the program ends. If a story rule comprising a theme and product is satisfied, assets that satisfy the theme and rule are selected at step 304. The reader will appreciate that the steps of selecting a theme, product and assets may be combined into a single step or done in various other combinations. An image product is created based on the selected assets at step 305 and the user is notified that a product is available for viewing at step 306.

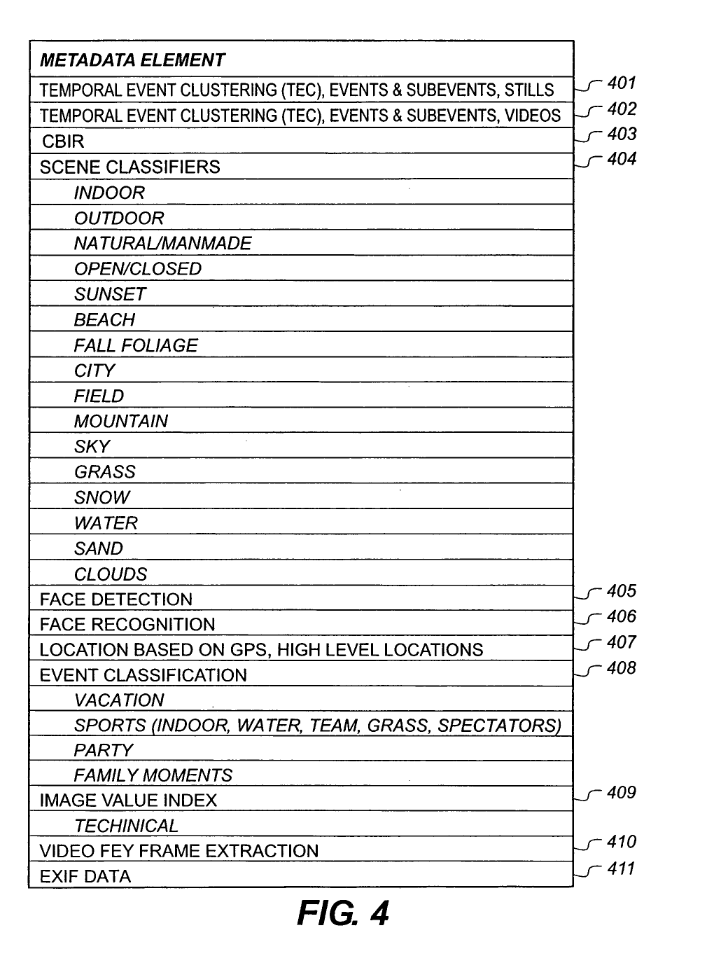

With reference to FIG. 4, there is illustrated a list of example metadata elements that can be generated by the system based on various characteristics of images that can be extracted based on algorithms that analyze images. Temporal event clustering of stills and videos 401, 402 are generated by automatically sorting, segmenting, and clustering an unorganized set of media into separate temporal events and sub-events. Content-based Image Retrieval (CBIR) 403 retrieves images from a database that are similar to an example (or query) image. Images may be judged to be similar based upon many different metrics, for example similarity by color, texture, or other recognizable content such as faces. This concept can be extended to portions of images or Regions of Interest (ROI). The query can be either a whole image or a portion (ROI) of the image. The images retrieved can be matched either as whole images, or each image can be searched for a corresponding region similar to the query. In the context of the current invention, CBIR may be used to automatically select assets that are similar to some other automatically selected asset. Scene classifiers identify or classify a scene into one or more scene types (e.g., beach, indoor, etc.) or one or more activities (e.g., running, etc.). Example scene classifiers are listed at 404. A face detector 405 is used to find as many faces as possible in image collections. Face recognition 406 is the identification or classification of a face to an example of a person or a label associated with a person based on facial features. Face clustering uses data generated from detection and feature extraction algorithms to group faces that appear to be similar. Location-based data 407 can include cell tower locations, GPS coordinates, and network routers. All image and video media have an associated location that may or may not be metadata archived with the image or video file. These are typically stored with the image as metadata by the recording device, which captures an image or sound. Location-based data can be very powerful when used in concert with other attributes for media clustering. Item 408 exemplifies identification or classification of a detected event into a semantic category such as birthday, wedding, etc. Media in an event are associated with the same setting or activity per a unit of time and preferably related to the subjective intent of the user or group of users. Media in a sub-event have similar content within an event. Within each event, media can also be clustered into separate groups of relevant content called sub-events. Media in an event are associated with same setting or activity, while media in a sub-event have similar content within an event. An image value index, or “IVI”, 409 is defined as the degree of importance (significance or usefulness/utility) that an individual user might associate with a particular asset. IVI algorithm development could utilize image features such as: sharpness and quality, camera-related metadata (exposure, time, date), image understanding (skin or face detection and size of skin/face area), and behavioral measures (viewing time, magnification, editing, printing, sharing). Video key frame extraction 410 is the process of extracting key-frames and/or salient shot, scene, or event, and the associated audio to provide a summary or highlight of a video sequence. EXIF data 411 is data generated by a recording device and is stored with the captured media file. For example, a digital camera might include various camera settings associated with an image such as f-stop, speed, and flash information. These camera generated data may also include GPS data indicating geographic location related to where an image was captured. All metadata, whether input by a user, provided by a recording apparatus, or inferred by a computer system can be used by the programmed computer system to generate additional metadata based on inferences that can be determined from existing metadata associated with various stored media files.

An embodiment of the present invention comprises a computer program executing on a computer system with a display that automatically creates a composite image product. A story theme is first chosen which defines a set of rules for selecting a number of assets to use in creating the image product. Based on the selected assets, a product representation is then selected which can include, for example, a hard-copy album, slide show, DVD, collage, multimedia presentation, screen saver, mug, t-shirt, greeting card, calendar, etc. These two steps are not completely independent; the product representation may impact the asset selection rules, or vice versa. An example story theme might be Mother's Day; a product representation might be a hard-copy album. The same asset selection rules may apply to other image product forms; for example, the images chosen to make a hard copy album might work just as well to make a DVD.

Part of the power of the program is that it allows automatic asset selection whereby the computer system selects a subset of images in an intelligent fashion so that, for example, all the pictures in a collection need not be included in the image product. The number of assets selected may be determined by the output product desired. For example, if a two minute multimedia presentation is selected at a transition rate of four seconds per slide, this would require thirty images. This constraint may be specified as part of a rule set.

The computer system may generate image products based on calendar entries that identify significant dates. The dates may be personally significant, such as anniversaries or birthdays, or they may be holidays such as Mother's Day or New Years Day. The data for these calendar dates may be input to the system by users or it may be inferred by the programmed computer system.

To illustrate calendar-driven stories, suppose user Alex is married, has young children and Mother's Day is May 13^{th}. The programmed computer system can be set to automatically create an image product at a pre-selected time, for example, one week in advance of that date. The computer can be set to alert Alex that a Mother's Day image product has been generated by the computer system and is ready for viewing. The alert can be a pop-up on the computer screen generated by an RSS reader while Alex is using the computer, or it can be a text message sent to his cell phone using an SMS system, etc. The Mother's Day image story theme can be, for example, a multimedia product which includes pictures of Alex's wife and her family.

The specific logic for suggesting a Mother's Day story for a particular user in the preferred embodiment is expressed in Prolog, and has the English equivalent as follows:
R-1. Given target date Date, suggest to user User story type “Mother's Day Album” and product “Mother's Day Multimedia Album” intended for recipient Recipient if:

R-1.1. Target date Date is a known recurring holiday Holiday

R-1.2. The Holiday is Mother's Day

R-1.3. The system user User is the spouse of the recipient Recipient

R-1.4. The recipient Recipient is a mother

Suppose the system manager 107 invokes the story suggester specifying the date May 13, 2007, and the rule base 114 includes the rule 0. The rule base may have other rules specifying different types of stories that are triggered based upon the date; the rule 0 is simply an example of one such rule. Assuming that Alex is a system user, and is married to Ann and Ann is a female parent, and that May 13, 2007 is the day Mother's Day was celebrated in the year 2007, the system will suggest that a Mother's Day Multimedia Album product be created for Alex, where the story type is Mother's Day Album. Facts such as the day that Mother's Day is celebrated in a given year may be represented as either an enumerated set of facts, one for each holiday and year, or using generalized rules. For example, in one preferred embodiment, the system explicitly has knowledge that Mother's Day is observed on the second Sunday of May.

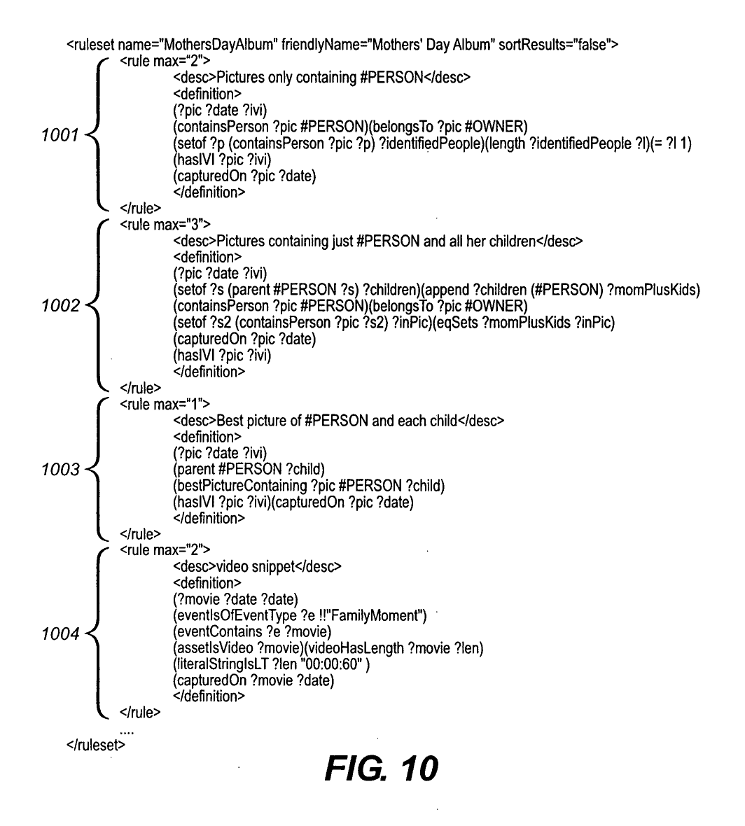

The story type defines a set of rules used to pick the assets to use to make a particular product. The smart asset selector 109 executes the rule set requested by the story suggester to determine the appropriate set of assets for the product being created. In the preferred embodiment, the rules making up a rule set are expressed in Prolog, using a version of Prolog where clauses are written in a parenthesized prefix form known as S-expressions. FIG. 10 contains a subset of the rules for the Mother's Day Album; a more complete set of rules might be expressed in English as follows:
R-1. Select assets satisfying the following constraints:

R-1.1. Begin with at most the two best pictures of the mother alone, shown as the rule 1001.

R-1.2. Next, at most the best three pictures of the mother with all children (no husband), shown as rule 1002.

R-1.3. Next, the best picture of the mother with each child individually from any year, shown as rule 1003.

R-1.4. Best pictures of the mother with her mother from any year (not shown).

R.1.5. Best pictures of the mother with family (children and husband) from past year (not shown).

R-1.6. Finally, at most two video clips, shown as rule 1004, where the video belongs to an event classified as type “Family Moments” and the video is less than 60 seconds in length.

“Best” may be defined according to a variety of programmed metrics, or a combination thereof, including various image value index (IVI) metrics. These criteria can be extended to other types of dates besides holidays. The above rules are merely exemplary; the Prolog language enables an arbitrary set of constraints to be defined. In a preferred embodiment, the exact definition of best is defined as appropriate using additional Prolog clauses.

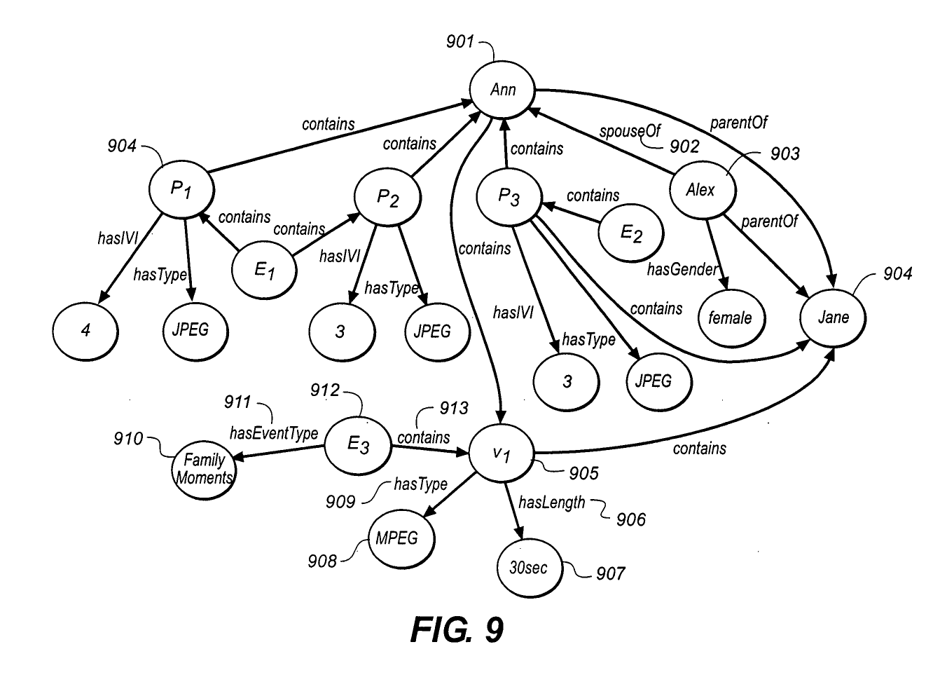

FIG. 9 illustrates a semantic network database containing an exemplary portion of the data associated with the above example. In one preferred embodiment, the data are represented as a semantic network using the RDF data model. Within RDF, each “fact” is represented as a statement of the form “subject-predicate-object”. The subjects are illustrated as nodes and the predicates are shown as labeled links connecting the nodes. For example, the fact “Ann is the spouse of Alex” is represented by the combination of the “subject” node 901, the labeled “predicate” link 902 and the “object” node 903. The entire set of data, including metadata associated with assets, user profile information, and auxiliary data is stored in a triplestore, a database optimized for storage of otherwise unstructured facts of the form subject-predicate-object. The reader will appreciate that other data models and storage mechanisms may be usefully employed to implement the present invention and that the invention is not limited to the exemplary embodiments described herein.

The story suggester requests that the smart asset selector compute the set of assets matching the rule set “Mother's Day Album.” The smart asset selector in turn requests that the inference engine execute the associated rules, determining which assets satisfy the constraints specified by the rules. Continuing the previous example, given the rule set 0 as the rule set “Mother's Day Album”, which is shown in part in FIG. 10 in its native Prolog form, and given a set of data including the subset illustrated in FIG. 9, the smart asset selector will return the set of pictures and videos that satisfy the specified constraints. As a specific example, rule 0, indicated in FIG. 10 as the code within box 1004, may be satisfied by the asset V1 (905), as V1 belongs to an event E2 (node 912 and link 913) classified as being of type “Family Moments” (910, 911) and the video is less than 60 seconds in length (906, 907).

A rule set specifies a set of assets. A rule set may also specify further constraints on the assets that are to be respected by the product generator. For example, a rule set may specify the order the assets are to be presented in the final product and/or how the assets are to be grouped. The scope of the invention includes all such constraints.

Another preferred embodiment of the present invention is in the form of an event driven story type. This story type is triggered based upon an upload of assets to the computer system. In one embodiment, the system, upon receipt of a set of assets, attempts to classify those assets as belonging to one or more event types. The system combines this event classification with additional information about the user to suggest a particular story type. In general, the programmed computer system includes:

an interest and activity ontology

a product catalog ontology, which associates specific product types with specific interests or activities

the ability to associate with people interests or activities from the interest and activity ontology.

The interest and activity ontology defines an extensible list of possible activities, interests and hobbies. For example, a subset of the ontology may include the following classes:
(1) Sporting Activities

1.a) Indoor Sports
1.a.1) Team Sports

1.b) Outdoor Sports
1.b.1) Team sports
   1.b.1.a) Baseball
   1.b.1.b) Soccer
   1.b.1.c) Football
(2) Social Gatherings

2.a) Parties
2.a.1) Wedding parties
2.a.2) Birthday parties
2.a.3) . . .

2.b) Solemn Occasions

A full ontology class can be scaled to contain an arbitrary amount of information. The computer system, upon uploading of a set of assets, for example, a series of photos from a digital camera, attempts to first group those assets into events and then classify the events according to the interest and activity ontology. In one preferred embodiment, the programmed computer system classifies assets belonging to one of the following example high level event types:

Outdoor Sports

Party

Family Moments

Vacation

These event types are selected because images can be categorized into these four categories using statistical techniques. These categories can be mapped to one or more classes from the previous activity and interest ontology. For example, the event type Outdoor Sports is mapped to the item 1.b Outdoor Sports in the ontology.

The product catalog likewise contains a set of possible product types, along with the activities/interests those products may be associated with:

Baseball Album (goes with baseball)

Soccer Album (goes with soccer)

Baseball DVD (goes with baseball)

Using this data, the system uses the following generalized rule:
R-1. For a given event featuring a particular person, if the person has a specific interest that matches a specific product, and that interest is an instance of the high-level classification that is associated with that event, then give the person that product.

Given the above, the system can suggest a themed story based upon an upload of a set of digital media assets. For example, suppose a father uploads a set of pictures from his daughter Jane's recent little league game, and the system knows the following information:

Jane likes baseball, known because either the system was explicitly told this by the user, or because the system was able to infer this information.

The baseball product is associated with the activity baseball, known because the manufacturer or vendor of the product has associated that metadata as part of the product description.

Baseball is a type of outdoor sport, which is a type of sport, known from an ontology of activities and interests that the system has been explicitly told, such as the previous interest and activity ontology.

The specific logic for picking a story based on automatically selecting a theme associated with a set of pictures is as follows in one preferred embodiment:
R-2. For a set of assets comprising given event Event, suggest product Product for user User if:

| | |
|---|---|
| R-2.1. | User owns event Event |
| R-2.1. | Event has classification EventType |
| R-2.3. | Event contains picture(s) featuring Person |
| R-2.4. | User is a parent of Person |
| R-2.5. | Person likes activity ActivityType |
| R-2.6 | Product goes with activity ActivityType |
| R-2.7 | Activity is a subclass of EventType |

This rule, along with many other such rules, is stored in the rule repository 114 and executed by the inference engine 111 when requested by the story suggestor 106, as illustrated in FIG. 1.

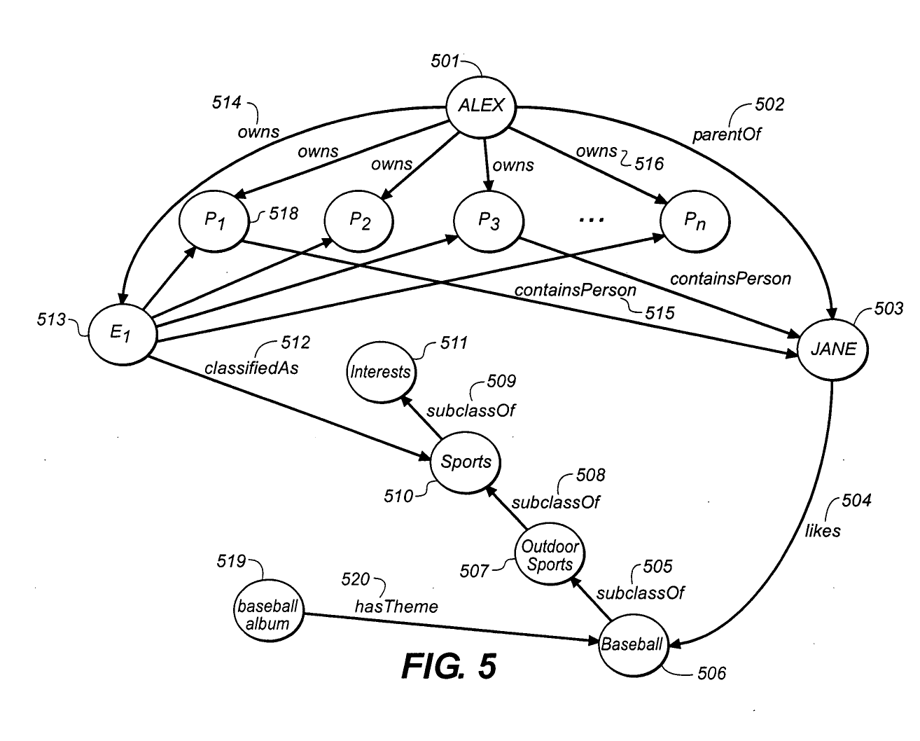

With reference to FIG. 5 there is illustrates a semantic network database containing an exemplary portion of the data associated with the above example. The subjects are illustrated as nodes and the predicates are shown as labeled links connecting the nodes. For example, the fact “Jane likes baseball” is represented by the combination of the “subject” node 503, the labeled “predicate” link 504 and the “object” node 506. The entire set of data, including metadata associated with assets, user profile information, and auxiliary data is stored in a triplestore. The reader will appreciate that other data models and storage mechanisms may be usefully employed to implement the present invention and that the invention is not limited to the exemplary embodiments described herein.

The previously described inference engine 111 of FIG. 1 executes rule 0 with respect to the set of data shown in FIG. 5 as follows. An event E₁ 513 is given; the inference engine is searching for a set of variable bindings for user User and product Product such that the constraints defined by rule 0 hold. Rule 0 consists of several subclauses 0 through 0, which in turn reference intermediate variables EventType, Person and ActivityType that must also simultaneously be bound to valid values such that the entire rule is true.

Event E₁ 513 is owned by user Alex 501, as shown by link 514, so Alex satisfies rule clause 0. Event E₁ contains pictures P₁ through P₁, 518. Moreover, Event E₁ has activity type Outdoor Sports, shown by nodes 513 and 510 and “classifiedAs” link 512. Consequently, rule clause 0 is satisfied by binding the variable EventType to Outdoor Sports.

A set of pictures making up an event is considered to feature a particular person if that person is portrayed in the pictures. More complex definitions of what it means for a set of pictures to feature a person may be defined to require that the person be predominantly portrayed in those pictures, for example, appearing in a majority of the pictures, etc. Using the simple definition that an event features a person if the person appears in a picture belonging to the event, the rule 0 is satisfied by binding the variable Person to Jane, in light of the statement represented by 518, 515 and 503. Clause 0 is satisfied by binding User to Alex, supported by the statement represented by 501, 502 and 503, that Alex is a parent of Jane. Clause 0 is satisfied by binding ActivityType to the class baseball, supported by the statement represented by 503, 504 and 506, that Jane likes baseball. Given the binding of ActivityType to baseball, clause 0 is satisfied by binding Product to the baseball album, using 519, 520 and 506. Given that baseball is a subclass of Outdoor Sports (506, 505, 507), the variable binding of Activity to baseball and EventType to Outdoor Sports satisfies clause 0, and so the entire rule 0 is satisfied given the variable binding of User to Alex and Product to baseball album.

As noted previously, the preferred embodiment uses a Prolog inferencing engine to search for solutions to rules, where the rules are represented using Prolog clauses, but other mechanisms for describing constraints may also be used.

Table 1 is intended to show some examples of rules and the associated metadata and/or algorithms required to make them work. These rules can be used in various combinations in a given rule set to facilitate automatic story generation. These rules are simply illustrative of the arbitrarily complex types of rules that may be expressed within the system.

TABLE 1

| | Required Metadata |
|---|---|
| Template Rule | and/or Algorithm |
| Select theme (eg. vacation, party) | User request and/or event |
| to find appropriate assets for story | classification |
| Eliminate images with poor quality | IVI |
| Put assets in chronological order | Date and time stamp |
| Eliminate duplicate images | Dup detector |
| Select best of similar images | Image similarity, IVI |
| Select images from each location in | GPS location data |
| collection | |
| Select best images of each person | Face detection, IVI |
| at event | |
| Select images proportionately to | Face detection |
| number of occurrences of person | |
| Select best of group shots | Face detection, IVI |
| Select appropriate music based on | Event classification, music |
| theme | classification, personal |
| | profile/preferences |
| Change music as themes change | Event classification, music |
| within a subevent | classification, personal |
| | profile/preferences |
| Select appropriate transitions based | Event classification, personal |
| on theme | profile/preferences |
| Select appropriate background | Event classification, personal |
| image based on theme | profile/preferences |
| Adjust dwell time relative to picture | IVI, other significance indicators |
| significance | (Favorites, shared, printed, etc) |

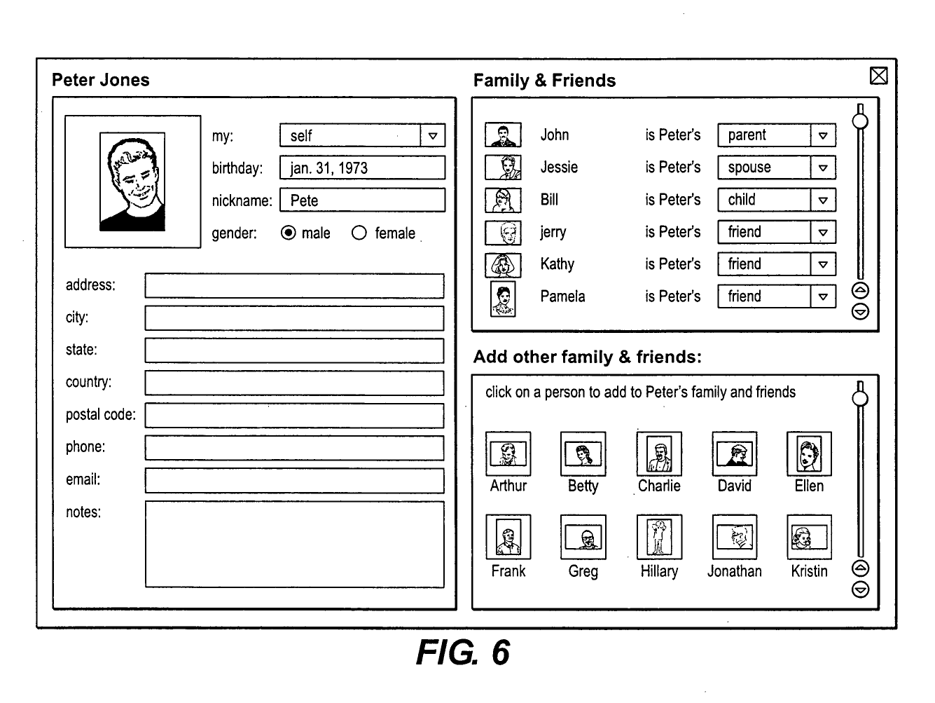

With reference to FIG. 6, there is illustrated an example user interface (UI) for entering profile metadata related to a person. Information fields in this UI include personal information for the person such as address, city, state, country, phone, email address, and other notes. The notes might include keywords such as nicknames, profession, physical characteristics, and a variety of other input data that the computer system will associate with the person. This profile also includes information about people such as family and friends which will also be associated by program with the profiled person. The depiction of user input information related to a person should not be limited only to the examples illustrated in FIG. 6. Related information which is associated with the person may also include information about persons, places, things, animals, etc., with example pictures, if available.

For familial relationships, the system does not require that the user enter all family relationships—one does not need to say, for example, that Jane is Ann's daughter, that Jane is Mary's grandchild, that Jane is Bill's niece, etc. Instead, the system requires only that the canonical relationships of spouse, and parent/child be entered; all other familial relationships are automatically inferred by the system. Relationships by marriage can likewise be inferred, such as mother-in-law, etc.; the system provides a way for the user to specify that such a relationship has terminated as a consequence of divorce.

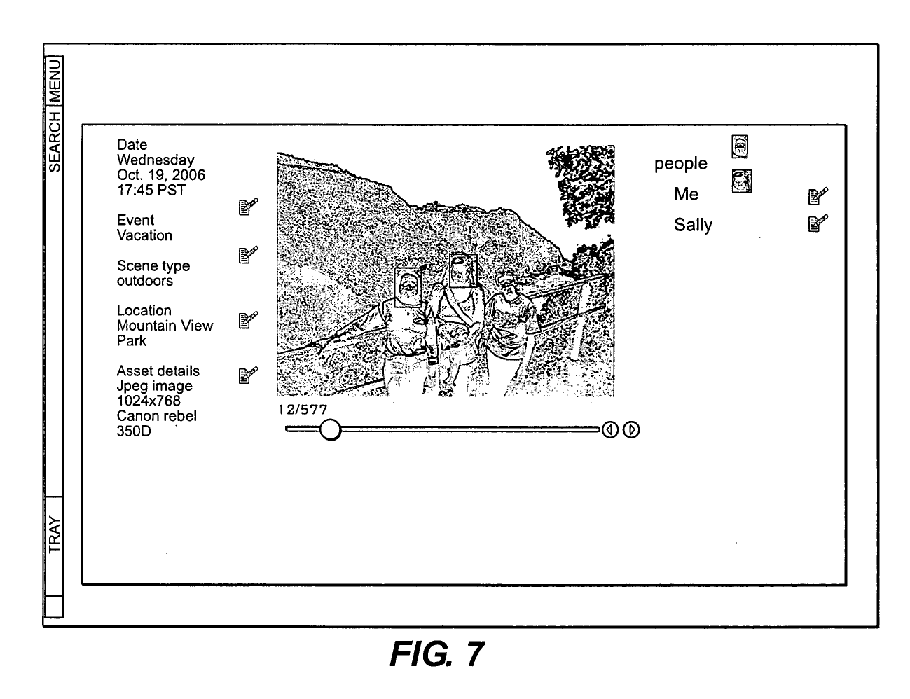

With reference to FIG. 7, there is illustrated an example user interface for entering metadata related to, for example, an image stored on the computer system database 113 of FIG. 1. Information fields in the UI include those which are associated with the image, or a person, place, animal, or thing also depicted in the image, and may also include information about other persons, places, things, animals, etc., which appear in the image. These fields include date information, an event field for describing an event related to the image, keywords entered by a user for facilitating a semantic inference with the image or searching. A location field for describing a location related to the image and an asset detail field also assist in compiling various types of metadata related to the image. The information fields might also include data unrelated to anything depicted in the image. Rather, the information may include contextual information. For example, if the image includes scenes from a soccer match an information field might state that the game was lost, or it may include information about who was coaching the team on that day, or it may include information about the weather (which can be obtained automatically by program generated metadata utilizing information available online together with EXIF data such as GPS location and time and date) or information about events preceding or following the match, and other data of unlimited variety that the programmed computer system associates with the stored image. Keywords may be added in the keyword field to facilitate searching for images. Facial recognition tools may be implemented to assist in generating metadata by automatically identifying persons depicted in the image for whom information is already stored based on those persons appearing in another image already stored in the database. For example, if a chain of relationships can be inferred based on family relationship metadata available for a group of persons, it's possible to generate a family tree.

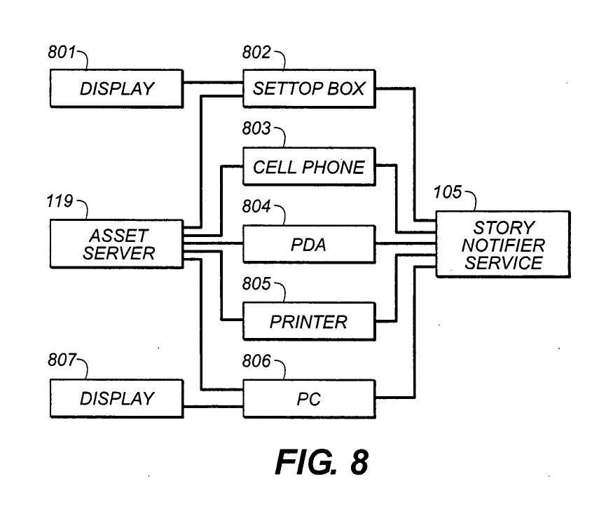

With reference to FIG. 8 the components story notifier service 105 and asset server 119 are coupled over network connections (not shown) that may include internet access or local networks, either of which may be accessed via standard cable type access and may also include wireless network access such as is common in cell networks. The story notifier service and asset server interact with various device types over the network connections to inform the user that a story has been created and to enable the user to view the story. Each of the illustrated device types such as a set top box 802, cell phone 803, PDA 804, printer 805 and PC 806, may include a story notifier 103 and story viewer 102 (not shown). For example, the user may have a story notifier running on settop box 802 connected to display 801. The user may view the story directly on the display. Alternatively, the user may receive notification via a story notifier running on cell phone 803, and then view the story either directly on a multimedia capable cell phone and/or on a larger format device, such as a PC 806 with an attached display 807.

### ALTERNATIVE EMBODIMENTS

It will be appreciated that, although specific embodiments of the invention have been described herein for purposes of illustration, various modifications may be made without departing from the spirit and scope of the invention. In particular, although one of the example preferred embodiments uses Prolog as the means for expressing and evaluating rules, the reader will appreciate that rules for suggesting stories may be formulated in other languages, and evaluated using other mechanisms than Prolog. Accordingly, the scope of protection of this invention is limited only by the following claims and their equivalents.

What is claimed is:

1. A method for automatically creating an image product comprising the steps of:
obtaining a plurality of digital media files associated with an event;
automatically classifying the event based on analyzing said plurality of digital media files;
automatically determining an output product based upon analyzing said digital media files; and
automatically selecting appropriate ones of said digital media files in accordance with requirements of said output product.

2. The method according to claim 1 wherein the requirements include a time duration for presentation of the media files.

3. The method according to claim 1 wherein the requirements include quality characteristics of the media files.

4. The method according to claim 1, wherein said step of automatically selecting appropriate ones of said digital media files further comprises the steps of:
obtaining a list of image characteristics associated with the event;
automatically determining which of the plurality of digital media files meet at least one predefined rule;
automatically ranking said digital media files that match said rules in accordance with the quality of said digital media files;
automatically compiling said digital media files having the highest ranking quality and meeting said predefined rule; and
automatically generating said image product using said compiled digital media files.

5. The method according to claim 4, wherein said at least one predetermined rule comprises requiring that a person, place, time, or geographic location associated with said event appears in the digital media file.

6. The method according to claim 4, wherein the step of automatically generating said image product further includes the step of arranging the media files on a visual background.

7. The method according to claim 4, wherein the step of automatically generating said image product further includes the step of calculating available time or space for the media files and calculating time or space required by the media files.

8. The method according to claim 4, wherein the step of automatically generating said image product further includes the step of storing the image product on a portable storage medium.

9. The method according to claim 4, wherein the step of automatically generating said image product further includes the step of transmitting the image product to a display device over a network.

10. The method according to claim 1, further comprising producing a second image product, comprising the steps of:
automatically determining a reoccurrence of said event;
automatically identifying a second plurality of digital media files relating to said reoccurrence of said event;
automatically determining an output product based on analyzing said second plurality of digital media files; and
automatically selecting an appropriate number of digital media files from said second set that coincides with the requirements of said second output product.

11. The method according to claim 10 wherein the reoccurrence is a weekly, monthly, or annual anniversary.

12. The method according to claim 1 wherein said digital media files, each include an associated image or video segment.

13. A method for automatically creating an image product comprising the steps of:
automatically analyzing a plurality of digital media files so as to obtain associated meta data and derived meta data with respect to said plurality of digital media files;
automatically determining the occurrence and number of occurrences of substantial similar meta data elements among said digital media files;
automatically grouping said digital media files based on the number of times a particular meta data element occurs among said plurality of digital media files;
automatically determining the classification associated with the most occurring meta data elements; and
automatically creating a digital media output product utilizing classifications associated with the most frequently occurring meta data elements incorporated therein.

14. A method according to claim 13, wherein said associated meta data and derived meta date is obtained using semantic searching that includes information related to a requester of said image product.

15. A method according to claim 14, wherein the classifications are hierarchical in construction with each classification consisting of one or more sub-classes, and wherein each sub-class in addition to selecting a specified multimedia digital file, selects a specified property/characteristic of said digital media file, wherein the total number of digital media files obtained are limited by a further sub-class which is either a constant or a computed value.

16. A program storage device readable by a computer system, tangibly embodying a program of instructions executable by the computer system to perform method steps for generating an image product, said method steps comprising:
detecting an image product trigger;
locating a plurality of digital media files associated with an event associated with the product trigger;
automatically classifying the plurality of digital media files based on analyzing metadata associated therewith;
automatically selecting ones of the plurality of digital media files based on the classifying step;
ranking the selected ones of the digital media files; selecting a product format based upon the event associated with the product trigger; and
generating an image product based on the selected product format including the ranked digital media files.

17. The program storage device of claim 16, wherein the product trigger is uploading a plurality of digital media files to the computer system.

18. The program storage device of claim 16, wherein the product trigger is a date flagged on a calendar of the computer system.

19. The program storage device of claim 16, wherein the ranking step further comprises the step of calculating an image value index.

20. The program storage device of claim 16, wherein the step of generating an image product further comprises the step of including only a best ranked subset of the ranked digital media files.
